(19) United States
(12) Patent Application Publication
(10) Pub. No.: US 2004/0248479 A1
(43) Pub. Date: Dec. 9, 2004

(54) Electrical drive device for a ship with elastically supported electric motor

(76) Inventors: Peter Hein, Berlin (DE); Christian Meyer, Berlin (DE)

Correspondence Address: HARNESS, DICKEY & PIERCE, P.L.C., P.O.BOX 8910, RESTON, VA, 20195, US

(21) Appl. No.: 10/487,916

(22) PCT Filed: Aug. 23, 2002
(86) PCT No.: PCT/DE02/03104

(30) Foreign Application Priority Data
Aug. 30, 2001 (DE) 101 43 713.7

(51) Int. Cl. B60L 11/02; B60L 11/16; B60L 11/18; B63H 21/17

(52) U.S. Cl. 440/6

(57) ABSTRACT

The device (100) is provided with an electric motor, located on the underside of a ship hull in a housing (12) arranged like a gondola. At least one propeller (2, 3) is coupled to the drive shaft (1), supporting the rotor (4) of the electric motor. In order that such a drive device may be resistant to shock loads, the stator (5) of the electric motor is fixed to the rotor (4) by means of a pivot bearing (9) and the module comprising rotor (4) and strator (5) is elastically supported both on the housing (12) and also the drive shaft (1).

This application is the national phase under 35 U.S.C. § 371 of PCT International Application No. PCT/DE02/03104 which has an International filing date of Aug. 23, 2002, which designated the United States of America and which claims priority on German Patent Application number DE 101 43 713.7 filed Aug. 30, 2001, the entire contents of which is hereby incorporated herein by reference.

### FIELD OF THE INVENTION

The invention generally relates to the field of propulsion devices for vessels. It is preferably applicable to the design configuration of an electric motor which includes a stator and a rotor and is arranged in a streamlined housing which can be arranged like a gondola on the lower surface of the hull of a vessel. Preferably the rotor is supported by a shaft which is mounted in the housing and to which at least one propeller is coupled.

### BACKGROUND OF THE INVENTION

In one known propulsion device, the rotor is in the form of a rotor with permanent-magnet excitation and includes a supporting structure with a tube-like mounting body and a magnetically active part. The rotor is arranged on a propulsion shaft to which at least one propeller is fitted and which is mounted in the housing of the propulsion device. The stator, including an electrically and magnetically active part, is fitted into the housing of the propulsion device such that power can be transmitted. The electric motor is in this case cooled by heat dissipation via the housing to the surrounding water.

In order to cool the end windings of the stator, air or an insulating oil can be circulated in the interior of the housing (WO 97/49605). Alternatively, it is possible to use a special thermal bridge (DE 199 02 837 A1). Additional cooling measures may include the use of closed-cycle coolers which are arranged in the casing-like mount part of the propulsion device (DE 198 26 229 A1).

In another known propulsion device with an electric motor that is arranged like a gondola, the stator is arranged with a radial gap in the housing, in order to make it possible to cool the stator and the rotor with a gaseous coolant which is supplied from the hull of the vessel via specific cooling channels (U.S. Pat. No. 5,403,216).

### SUMMARY OF THE INVENTION

An embodiment of the invention is based on an object of designing the propulsion device such that it can withstand shock loads and is thus also suitable for applications in fields of operation in which severe underwater pressure waves may occur.

In order to achieve this object, an embodiment of the invention provides for the stator to be fixed on the rotor via rotating bearings, and for the unit formed from the stator and rotor to be elastically supported both on the housing and on the propulsion shaft.

In a refinement of the propulsion device such as this, the electrically and magnetically active parts of the propulsion motor, which have a high mass, form a unit which is mounted within the housing and in a “damped” manner on the propulsion shaft. In the event of sudden pressure effects acting on the housing and the propulsion shaft of the propulsion device from the outside, these pressure effects act with a time delay and thus with a reduced shock effect on the electrically and magnetically active parts of the motor. The mechanical forces which act on the hull of the vessel via the suspension of the propulsion device (which is arranged like a gondola), in particular bending moments, are thus reduced.

The elastic and damped arrangement of the electrically and magnetically active parts of the electric propulsion motor also results in a reduction in the structure-borne sound which originates from the propulsion device. This thus makes it harder to use sonar to locate a vessel which is equipped with a propulsion device such as this. The rigid mechanical coupling between the rotor and the stator of the electric propulsion motor has the further advantage in the case of motors in which the rotor is fitted with permanent magnets for excitation purposes that the air gap between the rotor and the stator remains constant even in the event of shock loads on the propulsion device, and can thus be chosen to be very small.

In one refinement of an embodiment of the invention, the rotor includes a tube-like mounting body and an active part which is fitted to the mounting body and is elastically supported on the propulsion shaft, while the stator is mounted on the mounting body of the rotor and is elastically supported on the housing. In this case, it is expedient for the rotor to be mounted softly on the propulsion shaft both in the axial direction and in the radial direction, but to be designed to be torsionally stiff in the circumferential direction.

The radially rigid mounting of the stator on the mounting body of the rotor is expediently achieved by commercially available radial and axial bearings, which are preferably in the form of roller bearings. Sliding bearings are in contrast expediently used for the bearings for the rotor shaft, preferably those with hydrostatic oil circulation.

Commercially available damping elements may be used for the elastic support of the rotor on the shaft, such as those which are normally used, for example, for elastic couplings in a shaft run. The essential feature of damping elements such as these is that they are designed to be elastic in the radial and axial directions of the rotor and to be torsionally stiff in the circumferential direction of the rotor.

The same types of damping elements can be used for the elastic support of the stator on the housing of the propulsion device as for supporting the rotor on the shaft.

Since the elastic support of the stator on the housing of the propulsion device results in a space being formed between the stator and the housing, the stator cannot be cooled solely by heat dissipation via the housing to the surrounding water. Additional cooling measures must therefore be provided. This could be done by the use of closed-cycle coolers, which are arranged in the area of the wall of the supporting casing which connects the propulsion device to the hull of the vessel, or in the hull of the vessel, with a liquid coolant, in particular water, flowing through this closed-cycle cooler as well as through corresponding holes in the laminated stator core and in a cooling ring which surrounds the laminated core.

Cooling such as this may also be used for the end windings of the stator. Apart from this, circulating air flow can also be produced, which flows around the end windings of the stator and is cooled down in the area of the supporting casing for the propulsion device. If required, the bilge areas of the propulsion device, that is to say the housing parts which are arranged at the ends of the propulsion shaft, can also be used for cooling-down purposes.

### BRIEF DESCRIPTION OF THE DRAWINGS

Further advantages, features and details of the invention will become evident from the description of illustrated embodiments given hereinbelow and the accompanying drawings, which are given by way of illustration only and thus are not limitative of the present invention, wherein:

FIG. 1 shows a propulsion device, illustrated schematically in the form of a longitudinal section, and

FIG. 2 and FIG. 3 show a design refinement of the arrangement as shown in FIG. 1.

### DETAILED DESCRIPTION OF THE PREFERRED EMBODIMENTS

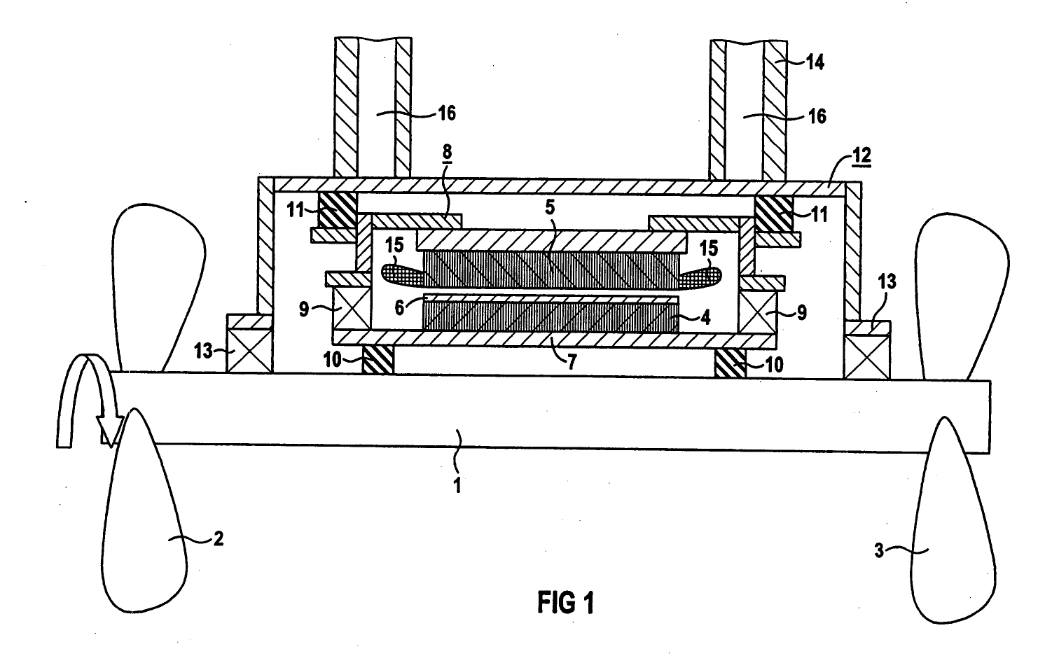

FIG. 1 shows the propulsion shaft 1 of an electric motor propulsion device 100 for a vessel, with the propulsion shaft being fitted with one propeller 2 and 3 at each end. Only the upper half of the electric motor which drives the propulsion shaft 1 is illustrated, in the form of a section. This electric motor includes a rotor 4 and a stator 5, with the rotor having an electrically active layer 6 in the form of permanent magnets, and being arranged on a tube-like mounting body 7. The stator 5 has a mounting housing 8 with two or more parts and which is fixed via rotating bearings 9 on the mounting body 7 of the rotor.

The unit including the rotor 5 and the stator 6 is supported by way of elastic damping elements 10 and 11 firstly on the propulsion shaft 1 and secondly on a housing 12 which holds the electric motor and the propulsion shaft. The propulsion shaft 1 is in this case mounted in the housing 12 via rotating bearings 13.

The housing 12 has an associated mounting casing 14 for attaching the propulsion device 100 to the hull of the vessel. The mounting casing 14 may have a double-walled configuration or may be provided with cooling channels 16 which surround it vertically, for example in order to carry cooling air.

In order to cool the stator 5, in particular the end windings 15, cooling air, for example, may be fed from the mounting casing 14 at one end of the electric motor into the internal space between the mounting housing 8 and the mounting body 7, and can be carried away at the other end of the electric motor. The cooling air could flow within the electric motor between the electrically active layer 6 of the rotor and the mounting body 7 in the axial direction. The stator housing 8 could have flow channels for cooling the stator and the stator windings, through which cooling water that is supplied from the mounting casing 14 flows.

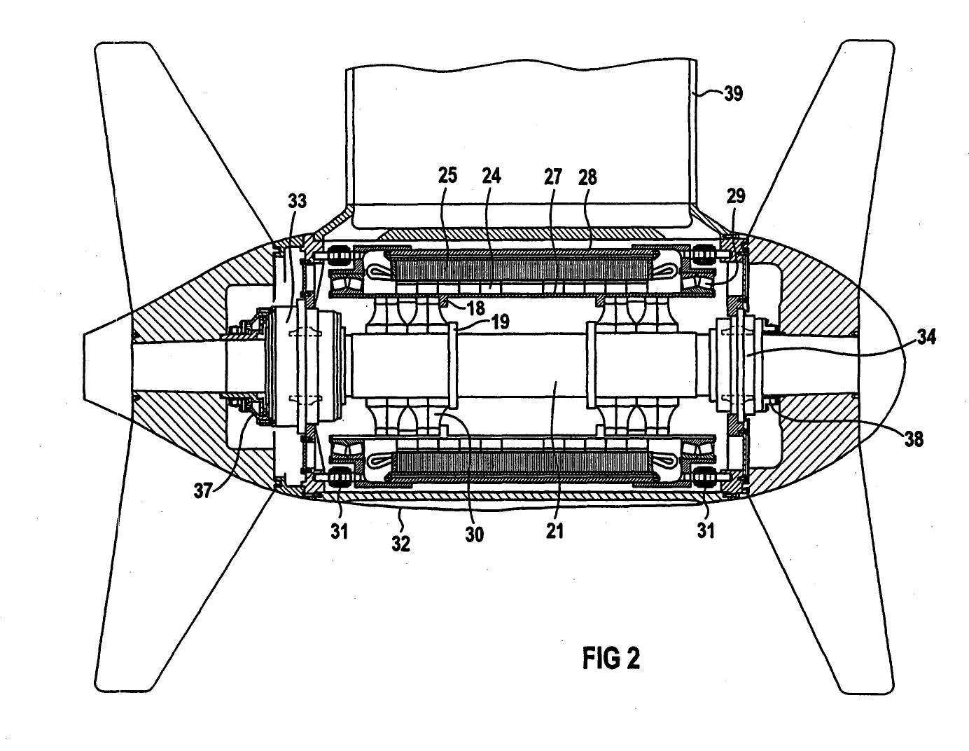

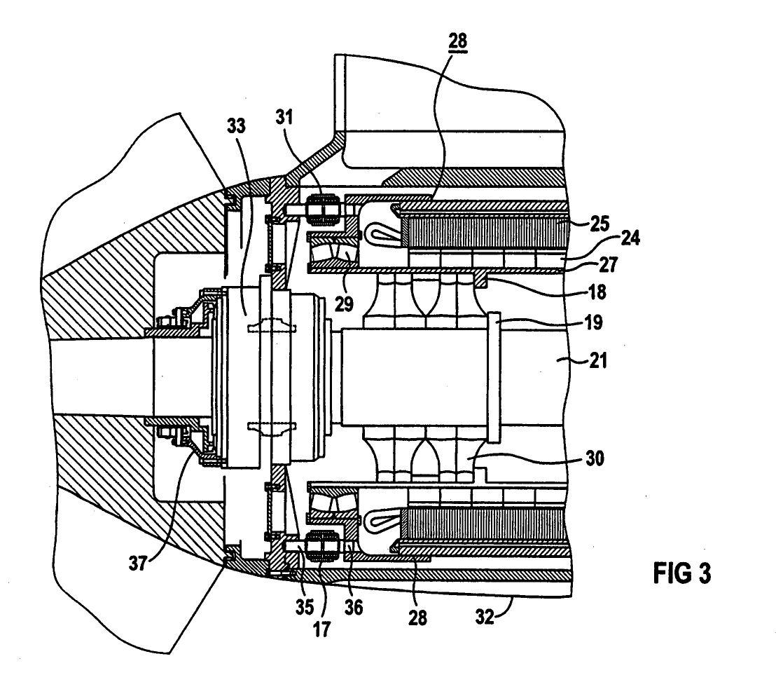

As is illustrated in FIG. 2 and in the somewhat enlarged detail in FIG. 3, the electric motor including the rotor 24 and stator 25 is arranged in a streamlined housing 32, which can be positioned by means of the mounting casing 39 like a gondola underneath the hull of a vessel. The mounting housing 28 for the stator is fixed to the mounting body 27 for the rotor 24 via rotating bearings 29 which are in the form of inclined roller bearings. This supporting body is elastically supported via damping elements 30 on the propulsion shaft 21. The damping elements 30 are in this case fixed axially on annular flanges 18 and 19.

The mounting housing 28 for the stator is supported via damping elements 31 on the housing 32. These damping elements each include a rubber body 17, which is mechanically coupled via bolts 35/36 to the mounting body 28 and to the housing 32.

The propulsion shaft 21, to which the rotor is fitted, is mounted in the housing 32 by way of sliding bearings 33 and 34. The sliding bearings are in this case sealed from the surrounding water by way of sealing device 37/38.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An electrical propulsion device for a vessel, comprising:
a housing, arranged on a lower surface of a hull of the vessel;
an electric motor, arranged in the housing and including a strator and a rotor; and
at least one propeller coupled to a propulsion shaft to which the rotor is fitted, wherein the strator is fixed on the rotor via rotating bearings, and wherein a unit formed from the stator and rotor is elastically supported on the housing and the propulsion shaft.

2. The propulsion device as claimed in claim 1, wherein the rotor includes a tube-shaped mounting body and an active part fitted to the mounting body and an elastically supported on the propulsion shaft, and wherein the stator is mounted on the mounting body of the rotor and is elastically supported on the housing.

3. The propulsion device as claimed in claim 1, wherein the support for the rotor on the propulsion shaft is designed to be soft in the axial and radial directions and torsionally stiff in the circumferential direction.

4. The propulsion device as claimed in claim 1, wherein the rotating bearing is in the form of a roller bearing.

5. The propulsion device as claimed in claim 1, wherein the bearings for bearing the propulsion shaft are in the form of sliding bearings.

6. The propulsion device as claimed in claim 2, wherein the rotating bearing is in the form of a roller bearing.

7. The propulsion device as claimed in claim 3, wherein the rotating bearing is in the form of a roller bearing.

8. The propulsion device as claimed in claim 2, wherein the bearings for bearing the propulsion shaft are in the form of sliding bearings.

9. The propulsion device as claimed in claim 3, wherein the bearings for bearing the propulsion shaft are in the form of sliding bearings.

10. The propulsion device as claimed in claim 4, wherein the bearings for bearing the propulsion shaft are in the form of sliding bearings.

11. The propulsion device as claimed in claim 6, wherein the bearings for bearing the propulsion shaft are in the form of sliding bearings.

12. The propulsion device as claimed in claim 7, wherein the bearings for bearing the propulsion shaft are in the form of sliding bearings.

13. An electrical propulsion device for a vessel, comprising:
a housing, including a stator and a rotor forming a unit; and
a propulsion shaft, to which at least one propeller is coupled, wherein the stator is coupled to the rotor via at least one rotateable bearing and wherein the unit is elastically supported on the housing and the propulsion shaft.

14. The propulsion device as claimed in claim 13, wherein the rotor includes a tube-shaped mounting body and an active part fitted to the mounting body and is elastically supported on the propulsion shaft, and wherein the stator is mounted on the mounting body of the rotor and is elastically supported on the housing.

15. The propulsion device as claimed in claim 13, wherein a support for the rotor on the propulsion shaft is designed to be soft in the axial and radial directions and torsionally stiff in the circumferential direction.

16. The propulsion device as claimed in claim 13, wherein the rotatable bearing is in the form of a roller bearing.

17. The propulsion device as claimed in claim 13, wherein the bearings are in the form of sliding bearings.
